(19) United States
(12) Patent Application Publication
(10) Pub. No.: US 2021/0053212 A1
(43) Pub. Date: Feb. 25, 2021

(54) COMPUTER-IMPLEMENTED METHOD FOR TRAINING A MODEL, METHOD FOR CONTROLLING, ASSISTANCE AND CLASSIFICATION SYSTEM

(71) Applicant: Robert Bosch GmbH, Stuttgart (DE)

(72) Inventor: Anna Constanze Haetty, Stuttgart (DE)

(21) Appl. No.: 16/998,515

(22) Filed: Aug. 20, 2020

(30) Foreign Application Priority Data
Aug. 21, 2019 (DE) 102019212477.1

(51) Int. Cl. B25J 9/16; G06N 20/00; B25J 13/00; G06K 9/62

(52) U.S. Cl. CPC B25J 9/161; G06K 9/6267; B25J 13/003; G06N 20/00

(57) ABSTRACT

A method for training a model, a classification system for voice or text classification, a method for controlling, and a assistance system. General-language word vectors and technical-language word vectors, and training data which include terms, are provided. A label is assigned to each of the terms, which indicates a specificity of the term with respect to a specialist field. A first word vector is determined as a function of the general-language word vectors and a second word vector is determined as a function of the technical-language word vectors, for a term from the training data. The model predicts a specificity of the term with respect to the specialist field as a function of the first word vector, the second word vector, and a difference vector. At least one parameter being determined for the model as a function of the specificity predicted for the term and the label of the term.

### CROSS REFERENCE

The present application claims the benefit under 35 U.S.C. § 119 of German Patent Application No. DE 102019212477.1 filed on Aug. 21, 2019, which is expressly incorporated herein by reference in its entirety.

### FIELD

The present invention is based on a computer-implemented method for training a model, in particular an artificial neural network, for terminology extraction or indexing of texts. The present invention additionally relates to a method for controlling and to an assistance and classification system.

### BACKGROUND INFORMATION

Automatic terminology extraction is used for the automatic retrieval of words or groups of words. It is desirable to improve automatic terminology extraction further and to expand the possibilities for their utilization.

### SUMMARY

In accordance with an example embodiment of the present invention, a computer-implemented method is provided for training a model, in particular of an artificial neural network, for terminology extraction or indexing of texts stipulates providing in a first phase general-language word vectors, which are based on a general-language collection of texts, and technical-language word vectors, which are based on a specialist field-specific collection of texts from a specialist field, training data being provided, which comprise terms, a label being assigned to each of the terms, which indicates a specificity of the term with respect to the specialist field, a first word vector being determined in a second phase for a term from the training data as a function of the general-language word vectors and a second word vector being determined for a word from the training data as a function of the technical-language word vectors; the model predicting a specificity of the term with respect to the specialist field as a function of the first word vector, as a function of the second word vector and as a function of a difference vector, which is defined as a function of the first word vector and of the second word vector, and at least one parameter being determined for the model as a function of the specificity predicted for the term and the label of the term. This makes it possible automatically to detect and classify particularly well so-called sub-technical terms, i.e., terms that occur both in general language as well as in technical language. These sub-technical terms are particularly relevant for the specificity since lay persons possibly do not recognize the technical meaning. Sub-technical terms and specific terms in texts are thus more readily detectable for classification.

It is preferably provided that training data are provided in the first phase, which comprise terms from a general-language text collection, the general-language word vectors being learned in the first phase in particular for a semantic word vector space model as a function of the general-language text collection. The general-language vector space is preferably learned as a preprocessing step prior to training if no predefined model is to be used or no predefined model exists.

It is preferably provided that training data are provided in the first phase, which comprise terms from the specialist field-specific text collection, technical-language word vectors being learned in the first phase in particular for a semantic word vector space model as a function of the specialist field-specific text collection. The specialty-specific vector space can be learned alongside in training if no predefined model is to be used or if no predefined model exists.

It is preferably provided that the model has a first channel for first word vectors and a second channel for second word vectors, the model having a third channel for a joint processing of respectively one of the first word vectors and of respectively one of the second word vectors. This is a particularly efficient architecture of the model.

It is preferably provided that a first word vector is determined for a first word as a first representation of the term in a first vector space for the first channel, a second word vector being determined as a second representation of the term in a second vector space for the second channel. These vectors are thus processed separately.

It is preferably provided that the first vector space and the second vector space are projected in a third vector space for the third channel, an element-wise difference vector being determined in the third vector space as a function of the first word vector and as a function of the second word vector. These vectors are thus additionally considered in parallel, i.e., jointly.

It is preferably provided that the first representation, the second representation and the difference vector are concatenated in a concatenated vector and that the specificity is determined as a function of the concatenated vector. This determination is especially suitable for sub-technical terms.

It is preferably provided that the model comprises an artificial neural network, which has a first dense layer in the first channel, a second dense layer in the second channel, and a third dense layer in the third channel, and a tensor difference layer following thereupon in the direction of forward propagation, the outputs of the first dense layer, of the second dense layer and of the tensor difference layer being concatenated in a concatenation layer, and a prediction layer, in particular a flattening layer being situated after the concatenation layer in the direction of forward propagation. This is a particularly efficient architecture.

In accordance with an example embodiment of the present invention, a method for controlling an at least partially autonomous vehicle, an at least partially autonomous mobile or stationary robot, an actuator, a machine, a household appliance or a power tool provides for the computer-implemented method for training a model to be carried out in a first phase, at least one term, in particular of a voice or text input, being determined in a second phase, an output signal of the model trained in this manner being determined as a function of the at least one term, a control signal for controlling being determined as a function of the output signal.

In accordance with an example embodiment of the present invention, an assistance system for controlling an at least partially autonomous vehicle, an at least partially autonomous mobile or stationary robot, an actuator, a machine, a household appliance or a power tool is designed to carry out the method.

In accordance with an example embodiment of the present invention, a classification system for language or text classification is designed to carry out the computer-implemented method for training a model in a first phase, and to determine in a second phase a term from a corpus in particular of a voice or text input, to determine an output signal of the model trained in this manner as a function of the at least one term, and to classify the term or the corpus into a collection of texts as a function of the output signal, to assign it to a domain, to determine a relevance for a group of users, in particular specialist or layperson, or to generate or modify a digital dictionary, an ontology or a thesaurus as a function of the term.

Further advantageous specific embodiments emerge from the following description and the figures.

### BRIEF DESCRIPTION OF THE DRAWINGS

FIG. 1 shows a system for automatic terminology extraction in accordance with an example embodiment of the present invention.

FIG. 2 shows a method for automatic terminology extraction in accordance with an example embodiment of the present invention.

FIG. 3 shows a method for controlling in accordance with an example embodiment of the present invention.

FIG. 4 shows an assistance system for controlling in accordance with an example embodiment of the present invention.

FIG. 5 shows a classification system for voice or text classification in accordance with an example embodiment of the present invention.

### DETAILED DESCRIPTION OF EXAMPLE EMBODIMENTS

Automatic terminology extraction, ATE, is concerned with the automatic retrieval of words or groups of words that characterize a specific specialist field. Terminology extraction is used for example in lexicon, thesaurus and ontology construction, in the search for information in databases, in text classification and in text clustering.

An important component of terminology extraction is the prediction of a specificity of a term. The specificity described a degree of difficulty of a term from the point of view of a layperson with respect to a specialist field. The decisive factor in this regard is to what degree a term relevant for a specialist field is also present in general language. Equivocal terms are important in predicting the specificity. These lie between the technical language and general language. For example, in German, the term “absperren” has an everyday meaning of “locking” and a specific meaning in craftsmanship of “sealing surfaces.” Equivocal terms are relevant for the specificity since laypersons possibly do not recognize the technical meaning. Equivocal terms may be more specific than a clearly recognizably highly specific term. Additionally, equivocal term are automatically difficult to recognize since they occur both in general language as well as in the technical language, but possibly with different meaning.

Using a numerical evaluation of a degree of specificity for a term x with respect to a technical language, as described below, it is possible to address new applications and to improve old applications.

For example, for classifying texts as texts for or by experts or as texts for or by laypersons, only terms are considered, instead of the complete texts. This significantly reduces the computing resources and computing time required for this purpose. This makes it possible to achieve an improved user modeling and text classification according to the degree of difficulty for users of web pages in specialist fields. For example, on “do-it-yourself” web pages, on which experts communicate with laypersons or do-it-yourselfers, users are able to be identified as experts or laypersons according to the specificity of the terms in the texts they compose or use.

For example, for indexing texts, more diverse keywords are considered as terms. These may be allocated with significantly reduced expenditure of computing resources and computing time. This makes it possible to represent simpler general as well as more precise technical keywords, which cover both terms for laypersons as well as experts. As a result, it is possible to find documents more quickly, regardless of whether an expert or a layperson uses a general-language term for the search.

Further applications concern the automatic generation of glossaries, learning systems, which provide assistance when learning a technical language, e.g., by laypersons. Generally, it is possible to produce a better characterization of terms in a terminology by a more refined characterization via the specificity.

Below, the term corpus designates a collection of texts. The following description refers to a general-language corpus and a domain-specific, i.e., specialist field-specific, corpus. As many different types of texts and topics as possible are covered for the general-language corpus. The general-language corpus is generated for example by crawling web pages. Freely available resources may also be used. An example is described by Gertrud Faaß and Kerstin Eckart, 2013, “SdeWaC—A corpus of parsable sentences from the web;” in Iryna Gurevych, Chris Biemann, and Torsten Zesch, editors, Language Processing and Knowledge in the Web, volume 8105 of Lecture Notes in Computer Science, pages 61-68. Springer, Berlin Heidelberg.

The domain-specific corpus is preferably composed of texts relating to a specialist field. The domain-specific corpus comprises, e.g., technical handbooks or is generated by crawling specialist field-specific web pages.

A semantic vector space model is used below in order to represent terms. For example, word2vec or fasttext are used as vector space models. Word2vec is described, for example, in Tomas Mikolov, Ilya Sutskever, Kai Chen, Greg Corrado, and Jeffrey Dean, 2013, “Distributed representations of words and phrases and their compositionality;” in Proceedings of the 26th International Conference on Neural Information Processing Systems—Volume 2, NIPS'13, pages 3111-3119, USA. Curran Associates Inc. Fasttext is described for example in P. Bojanowski*, E. Grave*, A. Joulin, T. Mikolov, 2012, “Enriching Word Vectors with Subword Information.”

Using a general-language text collection, it is possible to determine a semantic vector space model of general-language word vectors. Instead of training this using the general-language text collection, it is possible to fall back on the general-language word vectors that were already pre-trained using a general-language text collection. Using a specialty-specific text collection, it is possible to determine a semantic vector space model of specialty-specific word vectors. Instead of training the latter using the specialty-specific text collection, it is possible to fall back on the specialty-specific word vectors that were already pre-trained using a specialty-specific text collection.

Ground truth labeling or gold standard are used for determining the specificity. The labeling of the specificity is used to train a model for predicting the specificity. The labeling may be performed by a manual annotation of the training data. Semiautomatic labeling may also be provided. The latter is implemented, e.g., by a collection of topic-specific glossaries and base vocabulary lists. For example, all terms from topic-specific glossaries are labeled as highly specific. All terms from base vocabulary lists are labeled as being of low specificity. All other terms, which occur neither in the glossaries nor in the lists, are considered as non-terms, and are labeled as non-specific.

The model is for example an artificial neural network having parameters that are learned in training the model as a function of these labeled terms.

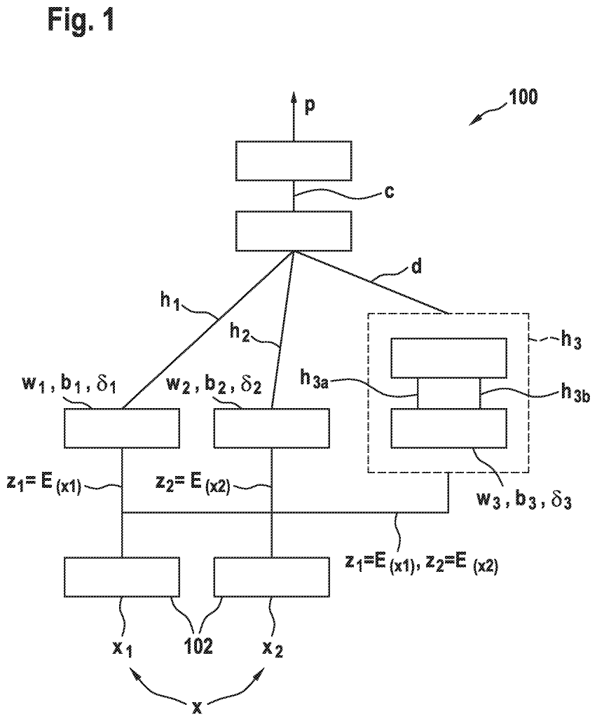

In the example, the model 100 described below with reference to FIG. 1 is used. Model 100 is a multi-channel neural network in the example.

The multi-channel neural network takes as input vectors GEN and SPEC, i.e., a first word vector z₁ and a second word vector z₂. For a specific term x, the first word vector z₁ is determined as a function of general-language word vectors. For the same term x, the second word vector z₂ is determined as a function of specialist field-specific word vectors. A first word index x₁ and a second word index x₂ below indicate the same term x. The two word vectors are respectively processed separately in a channel. In addition, a difference vector is determined as a function of the two word vectors. For this purpose, the two word vectors are first mapped in the same vector space using a third channel in the network. This is accomplished for example using a shared layer or a Siamese layer: The word vectors are processed in parallel using the same shared layer or Siamese layer and are thereby mapped in the same vector space. Subsequently, an element-wise difference vector is calculated in a tensor difference layer. Finally, all channels are concatenated.

Subsequently, a classification is performed on the basis of the entire information.

Mathematically, the exemplary multi-channel neural network is defined as follows for a first channel h₁, a second channel h₂ and a third channel h₃ with the parts h₃ₐ, h_{3b}:

h₁=σ₁(W₁*E(x₁)+b₁)

h₂=σ₂(W₂*E(x₂)+b₂)

h₃ₐ=σ₃(W₃*E(x₁)+b₃)

h_{3b}=σ₃(W₃*E(x₂)+b₃)

d=|h₃ₐ−h_{3b}|;d∈ [symbol] ^{l}

c=h₁∥h₂∥d;c∈ [symbol] ^{3l}

p=softmax(c)

In this instance, x indicates a word; E(x) an embedding layer, including a function E:xᵢ→z₁, which maps an index of a word xᵢ onto its corresponding n-dimensional word vector zᵢ; W indicates respective weight matrices, b a respective bias, σ a respective activation function, d a difference vector from a tensor difference layer, c a concatenated vector from a concatenation layer, p a specificity from a prediction layer and l indicates a variable of the respective layer. The structure of the respective layers is defined in the example by the respective mathematical equation.

The difference vector d is defined as a function of the first word vector z₁=E(x₁) and of the second word vector z₂=E(x₂).

The model 100 in the example comprises an artificial neural network. In the example, the first channel h₁ is a first hidden layer of the artificial neural network, in particular a first dense layer. The second channel h₂ in the example is a first hidden layer of the artificial neural network, in particular a second dense layer. The third channel h₃ in the example is a third hidden layer of the artificial neural network, in particular the shared layer and a tensor difference layer following thereupon in the direction of forward propagation. In the example, the inputs are the first word index x₁ and the second word index x₂. The word indices are mapped in an embedding layer 102 onto the word vectors. In FIG. 1, the shared layer is shown having the same inputs since the same word vectors are used, which are also used for the first dense layer and the second dense layer. The outputs of the first dense layer, the second dense layer and the tensor difference layer are concatenated in a concatenation layer. In the direction of forward propagation, a prediction layer, in particular a flattening layer, is situated after the concatenation layer.

The weights in the weight matrices for example are learned as a function of the specificity p and the training data as parameters of this multi-channel neural network. The specificity p is indicated for a specific vector GEN, i.e., the first word vector x₁, designated for this purpose on the first channel h₁ and on the third channel h₃, and a specific vector SPEC, i.e., the second word vector x₂, designated for this purpose on the second channel h₂ on the third channel h₃ by an output of the prediction layer.

In training, a label is assigned to a specific term x, which indicates its specificity. For term x, respectively the first word vector z₁, and the second word vector z₂, are determined, and the specificity p is predicted. Depending on the predicted specificity p and the specificity specified by the label, the weights are determined from the weight matrices W. The three labels for the specificity are for example “non-specific,” “somewhat specific” and “highly specific.”

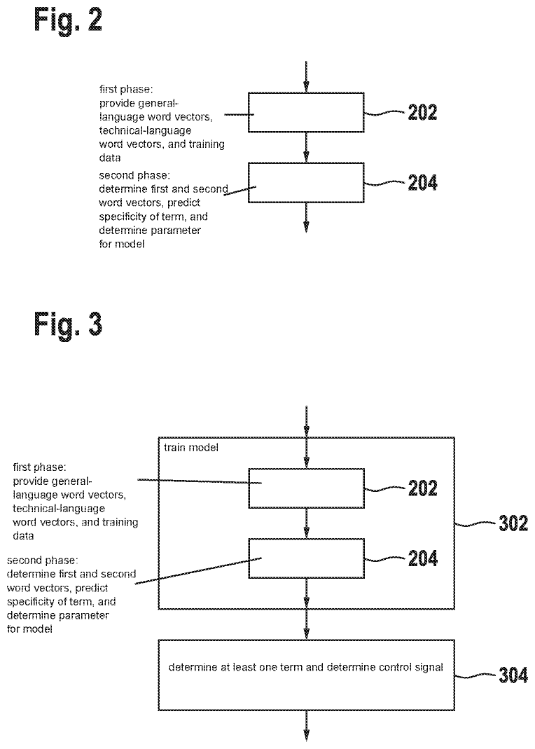

A computer-implemented method for training model 100 is described below with reference to FIG. 2. In the method, an artificial neural network, the multi-channel neural network in the example, is trained for terminology extraction or indexing of texts.

In a first phase 202, general-language word vectors, which are based on a general-language text collection, and technical-language word vectors, which are based on a specialist field-specific text collection from a specialist field, are provided.

The general-language word vectors define the semantic vector space model by which general-language word vectors are determined. The general-language word vectors may be previously trained word vectors according to word2vec or fasttext.

In the first phase 202, training data may be optionally provided, which comprise terms from a general-language text collection generated as previously described. In the first phase, in this case, the general-language word vectors, i.e., the semantic word vector space model for the latter, are learned as a function of the general-language text collection.

In the first phase 202, training data may be optionally provided, which comprise terms from a specialist field-specific text collection generated as previously described. In the first phase, in this case, the technical-language word vectors, i.e., the semantic word vector space model for the latter, are learned as a function of the specialist field-specific text collection.

In the example, the embedding layer for the multi-channel neural network is provided as a function of the learned or the predefined word vectors.

In the first phase 202, additionally training data are provided for training model 100, i.e., the multi-channel network in the example.

The training data comprise in the example terms to which respectively one label is assigned. The label indicates a specificity of the respective term in relation to a specific specialist field. The terms are labeled for example as highly specific, of low specificity and as non-specific depending on information from glossaries or lists, as previously described.

In a second phase 204, for respectively one term from the training data, a first word vector x₁ is determined as a function of the general-language word vectors and a second word vector x₂ is determined as a function of the technical-language word vectors.

In the second phase 204, model 100 predicts the specificity p of the term as a function of the first word vector z₁, as a function of the second word vector z₂ and as a function of the difference vector d, which was determined for this first word vector z₁ and this second word vector z₂.

Model 100 comprises the first channel h₁ for the first word vector z₁ and the second channel h₂ for the second word vector z₂. Model 100 comprises the third channel h₃ for a joint processing of the first word vector z₁ and the second word vector z₂.

In the second phase 204, at least one parameter is determined for model 100 as a function of the specificity p predicted for the term and the specificity of the term x specified by the label. In the example, the weights from the weight matrices W are adapted as a function of the specificity of term x specified by the label and of the predicted specificity p.

A multitude of terms and their labels are used in training in order to train model 100 using a multitude of first and second word vectors.

The first word vector z₁ is determined as a first representation z₁=E(x₁) in a first vector space for the first channel h₁.

The second word vector z₂ is determined as a second representation z₂=E(x₂) in a second vector space for the second channel h₂.

The portion h₃ₐ represents a third representation of the one first word vector z₁ in a third vector space for the third channel h₃. Part h_{3b} represents a fourth representation of the one second word vector z₂ in a third vector space for the third channel h₃. These representations are vectors. For these vectors, the element-wise difference vector d is determined.

The output of the first dense layer for the first representation z₁=E(x₁), the output of the second dense layer for the second representation z₂=E(x₂) and the difference vector d are concatenated into the concatenated vector c, and the specificity p is determined as a function of the concatenated vector c in particular by applying the softmax function to vector c.

FIG. 3 shows a method for controlling, which is used to control an at least partially autonomous vehicle, an at least partially autonomous mobile or stationary robot, an actuator, a machine, a household appliance or a power tool.

In a first phase 302 of the method for controlling, the computer-implemented method for training a model 100 is carried out as described above.

In a second phase 304 of the method for controlling, at least one term in particular of a voice or text input is determined and as a function of the at least one term an output signal of the model 100 trained in this manner is determined.

A control signal for controlling is determined in the second phase 304 as a function of the output signal.

The partially autonomous vehicle is controlled for example via voice control, in that the term is detected in a voice input and an action in the vehicle is triggered as a function of the specificity for the term. It is possible, for example, to operate a multimedia system independently of keywords from the specialist field of multimedia systems by more general voice inputs.

In parallel, the described term specificity classification is performed in order to obtain knowledge about a dialog. Sentences spoken in dialog are enriched with this knowledge. Whole sentences from the dialog and the enrichment may in turn be processed by another context-based model adapted to the task in order to trigger an action in the vehicle.

For at least partially autonomous mobile or stationary robots, an improved control is thereby achieved, for example. The actuator, the machine, the household appliance or the power tool may be controlled in a comparable manner.

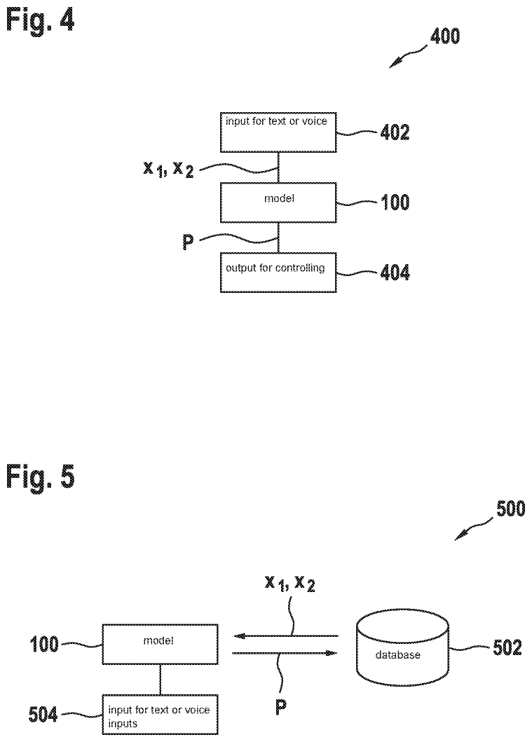

An assistance system 400 for controlling the at least partially autonomous vehicle, the at least partially autonomous mobile or stationary robot, the actuator, the machine, the household appliance or the power tool is shown schematically in FIG. 4.

Assistance system 400 is designed to carry out the described methods. Assistance system 400 comprises model 100, an input 402 for text or voice inputs or information about these and an output 404 for controlling. In the example, input 402 is designed to generate the first word vector z₁ and the second word vector z₂. Output 404 is designed to generate the control signal as output signal of model 100 as a function of the specificity p. For example, assistance system 400 is designed to detect a text or voice command in a dialog and to output a control signal for controlling the multimedia system based on the text or voice command. Assistance system 400 is designed for example to perform in parallel the described term specificity classification in order to obtain knowledge about the dialog. Assistance system 400 is designed for example to enrich sentences spoken in the dialog with this knowledge. Assistance system 400 is designed for example to process whole sentences from the dialog and the enrichment in an adapted context-based model in order to determine the control signal.

FIG. 5 schematically shows a classification system 500 for voice or text classification. Classification system 500 comprises a database 502, an input 504 for text or voice inputs and model 100. The database stores a collection of texts, in particular a multitude of corpora. Classification system 500 is designed to carry out in a first phase the computer-implemented method for training model 100 as a function of first word vectors z₁ and second word vectors z₂. In a second phase, a term x from one of the corpora is determined in particular as a function of a voice or text input. As a function of term x, an output signal is determined, in particular the specificity p, which the model 100 trained in this manner predicts for term x.

The term or the corpus is in this example classified into the collection of texts or assigned to a domain as a function of the output signal. It may be provided to determine a relevance for a user group, in particular specialist or layperson, or to generate or modify a digital dictionary, an ontology or a thesaurus as a function of the term.

What is claimed is:

1. A computer-implemented method for training a model for terminology extraction or indexing of texts, the method comprising:
in a first phase, providing (i) general-language word vectors which are based on a general-language text collection, (ii) technical-language word vectors which are based on a specialist field-specific text collection from a specialist field, and (iii) training data which include terms, a label being assigned to each of the terms, which indicates a specificity of the term with respect to the specialist field; and
in a second phase, (i) determining, for a term of the training data, a first word vector as a function of the general-language word vectors and a second word vector as a function of the technical-language word vectors, (ii) predicting, by the model, a specificity of the term with respect to the specialist field as a function of the first word vector, as a function of the second word vector, and as a function of a difference vector which is defined as a function of the first word vector and of the second word vector, and (iii) determining at least one parameter for the model as a function of the specificity predicted for the term and the label of the term.

2. The method as recited in claim 1, wherein the model is an artificial neural network.

3. The method as recited in claim 1, wherein the training data include terms from a general-language text collection, and wherein the general-language word vectors are learned in the first phase for a semantic word vector space model as a function of the general-language text collection.

4. The method as recited in claim 1, wherein the training data include terms from a specialist field-specific text collection, and wherein the technical-language word vectors are learned in the first phase for a semantic word vector space model, as a function of the specialist field-specific text collection.

5. The method as recited in claim 1, wherein the model has a first channel for first word vectors and a second channel for second word vectors, and wherein the model has a third channel for a joint processing of respectively one of the first word vectors and respectively one of the second word vectors.

6. The method as recited in claim 5, wherein the first word vector is determined as a first representation of the term in a first vector space for the first channel, the second word vector being determined as a second representation of the term in a second vector space for the second channel.

7. The method as recited in claim 6, wherein the first vector space and the second vector space are projected into a third vector space for the third channel, an element-wise difference vector being determined in the third vector space as a function of the first word vector and as a function of the second word vector.

8. The method as recited in claim 7, wherein the first representation, the second representation, and the difference vector are concatenated into a concatenated vector, and the specificity is predicted as a function of the concatenated vector.

9. The method as recited in claim 5, wherein the model includes an artificial neural network, which has a first dense layer in the first channel, a second dense layer in the second channel, and a third dense layer in the third channel, and a tensor difference layer following in a direction of forward propagation, outputs of the first dense layer, of the second dense layer, and of the tensor difference layer being concatenated in a concatenation layer, and a prediction layer being situated following the concatenation layer in the direction of forward propagation.

10. The method as recited in claim 9, wherein the prediction layer is a flattening layer.

11. A method for controlling an at least partially autonomous vehicle, or an at least partially autonomous mobile, or stationary robot, or an actuator, or a machine, or a household appliance, or a power tool, the method comprising:
in a first phase, carrying out a computer-implemented method for training a model, the computer implemented method including:
providing (i) general-language word vectors which are based on a general-language text collection, (ii) technical-language word vectors which are based on a specialist field-specific text collection from a specialist field, and (iii) training data which include terms, a label being assigned to each of the terms, which indicates a specificity of the term with respect to the specialist field, and
(i) determining, for a term of the training data, a first word vector as a function of the general-language word vectors and a second word vector as a function of the technical-language word vectors, (ii) predicting, by the model, a specificity of the term with respect to the specialist field as a function of the first word vector, as a function of the second word vector, and as a function of a difference vector which is defined as a function of the first word vector and of the second word vector, and (iii) determining at least one parameter for the model as a function of the specificity predicted for the term and the label of the term; and
in a second phase, determining at least one term, the at least one term being a voice input or a text input, an output signal of the trained model being determined as a function of the at least one term, a control signal for controlling being determined as a function of the output signal.

12. An assistance system for controlling an at least partially autonomous vehicle, or an at least partially autonomous mobile, or a stationary robot, or an actuator, or a machine, or a household appliance or a power tool, the assistance system configured to:
in a first phase, train a model, for the training o of the model, the assistance system being configured to:
provide (i) general-language word vectors which are based on a general-language text collection, (ii) technical-language word vectors which are based on a specialist field-specific text collection from a specialist field, and (iii) training data which include terms, a label being assigned to each of the terms, which indicates a specificity of the term with respect to the specialist field, and
(i) determine, for a term of the training data, a first word vector as a function of the general-language word vectors and a second word vector as a function of the technical-language word vectors, (ii) predict, by the model, a specificity of the term with respect to the specialist field as a function of the first word vector, as a function of the second word vector, and as a function of a difference vector which is defined as a function of the first word vector and of the second word vector, and (iii) determine at least one parameter for the model as a function of the specificity predicted for the term and the label of the term; and
in a second phase, determine at least one term, the at least one term being a voice input or a text input, an output signal of the trained model being determined as a function of the at least one term, a control signal for controlling being determined as a function of the output signal.

13. A classification system for voice or text classification, the classification configured to:
in a first phase, train a model, for the training o of the model, the assistance system being configured to:
provide (i) general-language word vectors which are based on a general-language text collection, (ii) technical-language word vectors which are based on a specialist field-specific text collection from a specialist field, and (iii) training data which include terms, a label being assigned to each of the terms, which indicates a specificity of the term with respect to the specialist field, and
(i) determine, for a term of the training data, a first word vector as a function of the general-language word vectors and a second word vector as a function of the technical-language word vectors, (ii) predict, by the model, a specificity of the term with respect to the specialist field as a function of the first word vector, as a function of the second word vector, and as a function of a difference vector which is defined as a function of the first word vector and of the second word vector, and (iii) determine at least one parameter for the model as a function of the specificity predicted for the term and the label of the term; and
in a second phase, determine at least one term from a corpus, the term from the corpus being a voice input or text input, determine an output signal of the trained model as a function of the at least one term, and to; (i) classify the at least one term or the corpus into a collection of texts as a function of the output signal, or (ii) assign the at least one term to a domain, or (iii) determine a relevance for a group of users, or (iv) to generate or modify a digital dictionary, or an ontology or a thesaurus, as a function of the at least one term.

14. The classification system as recited in claim 13, wherein the group of users are specialists or laypersons.

15. A non-transitory machine-readable storage medium on which is stored a computer program for training a model for terminology extraction or indexing of texts, the computer program, when executed by a computer, causing the computer to perform:
in a first phase, providing (i) general-language word vectors which are based on a general-language text collection, (ii) technical-language word vectors which are based on a specialist field-specific text collection from a specialist field, and (iii) training data which include terms, a label being assigned to each of the terms, which indicates a specificity of the term with respect to the specialist field; and
in a second phase, (i) determining, for a term of the training data, a first word vector as a function of the general-language word vectors and a second word vector as a function of the technical-language word vectors, (ii) predicting, by the model, a specificity of the term with respect to the specialist field as a function of the first word vector, as a function of the second word vector, and as a function of a difference vector which is defined as a function of the first word vector and of the second word vector, and (iii) determining at least one parameter for the model as a function of the specificity predicted for the term and the label of the term.
